(19) United States
(12) Patent Application Publication
(10) Pub. No.: US 2025/0137326 A1
(43) Pub. Date: May 1, 2025

(54) LADDER

(71) Applicant: TrenchTech, Inc., Morrisville, PA (US)

(72) Inventors: Carl James Lamb, JR., Hedgesville, WV (US); Connor Joseph Kerrigan, Maple Glen, PA (US); Jeffery Evinger, Duncannon, PA (US)

(73) Assignee: TrenchTech, Inc., Morrisville, PA (US)

(21) Appl. No.: 18/933,492

(22) Filed: Oct. 31, 2024

Related U.S. Application Data
(60) Provisional application No. 63/594,627, filed on Oct. 31, 2023.

(51) Int. Cl. E06C 1/34; E02D 17/08; E06C 1/39; E06C 7/18; E06C 7/50

(52) U.S. Cl. CPC E06C 1/34; E02D 17/08; E06C 1/39; E06C 7/182; E06C 7/505

(57) ABSTRACT

A ladder may be provided for mounting to a structure. The ladder may include one or more side rails, a plurality of rungs, one or more arms, one or more legs, and an adjustment assembly. Each of the plurality of rungs may extend between the first side rail and the second side rail. When the ladder is mounted to a structure, the one or more arms may be configured to abut an inside surface of the structure and maintain a predetermined distance between the plurality of rungs and the structure. The one or more legs may be configured to extend proximate to an outside surface of the structure when the ladder is mounted to the structure. The one or more legs may be configured to hinder movement of the ladder in the second direction. The adjustment assembly may be configured to be operated to secure the ladder to the structure.

### CROSS-REFERENCE TO RELATED APPLICATIONS

This application claims the benefit of U.S. Provisional Application No. 63/594,627 filed on Oct. 31, 2023, the entire contents of which is incorporated herein by reference in its entirety.

### BACKGROUND

A ladder may be leaned or placed against a structure. A user may climb the ladder in order to safely access areas that would be otherwise difficult to access. A ladder may be used to ascend a structure or descend a structure. For example, a ladder may be used to descend a wall of a trench.

### SUMMARY

A ladder may be provided for mounting to a structure. The structure may be a wall of a trench shoring system that is configured to be placed inside a trench. The ladder may comprise one or more side rails (e.g., such as a first side rail and a second side rail), a plurality of rungs, one or more arms, one or more legs, and an adjustment assembly. The first side rail and the second side rail may extend in a first direction. The first side rail and the second side rail may be parallel. Each of the plurality of rungs may extend between the first side rail and the second side rail. The one or more arms may extend in a second direction. The second direction may be substantially orthogonal to the first direction. When the ladder is mounted to a structure, the one or more arms may be configured to abut an inside surface of the structure and maintain a predetermined distance between the plurality of rungs and the structure. The predetermined distance may be measured between a respective rear surface of each of the plurality of rungs and the inside surface of the structure. The one or more legs may be configured to extend proximate to an outside surface of the structure when the ladder is mounted to the structure. The one or more legs may be configured to hinder movement of the plurality of rungs in the second direction. The adjustment assembly may be configured to be operated to secure the ladder to the structure.

The adjustment assembly may be configured to be operated from the inside surface of the structure to secure the ladder to the structure. Additionally or alternatively, the adjustment assembly may be configured to be operated from the outside surface of the structure to secure the ladder to the structure. The one or more legs may be adjusted to abut the structure when the adjustment assembly is operated. The one or more legs may be attached to an adapter that is configured to slidingly secure the leg to the ladder. The adjustment assembly may be configured to be operated to adjust the ladder between a mounting position and a secured position. The adapter may include a fastener that is configured to move within a slot defined in a platform of the ladder, for example, to guide the adapter in the second direction when the adjustment assembly is operated. The adjustment assembly may include a hand crank that is configured to be operated by a user to secure the ladder to the structure. The one or more arms may be configured to abut the inside surface of the structure and the one or more legs may be configured to abut the outside surface of the structure when the ladder is in the secured position. The one or more legs may be spaced a first distance from the plurality of rungs when the ladder is in the mounting position. The one or more legs may be spaced a second distance from the plurality of rungs when the ladder is in the secured position. The first distance may be greater than the second distance.

The ladder may include a first slot on a first side of the ladder and a second slot on a second side of the ladder. Each of the first slot and the second slot may be configured to receive one or more bolts, for example, to enable adjustment of a distance between the leg and the first and second side rails. The ladder may include a platform that extends between the leg and the first and second side rails. The platform may define an upper surface and rail portions on opposed sides of the upper surface. The first slot on the first side of the ladder may be defined in a first rail portion and the second slot on the second side of the ladder may be defined in the second rail portion. The first slot may include two portions that extend in the range of 5 to 8 inches that are spaced apart in the range of 3 to 5 inches. The second slot may include two portions that extend in the range of 5 to 8 inches that are spaced apart in the range of 3 to 5 inches. The first slot may include one portion that extends in the range of 16 to 20 inches. The second slot may include one portion that extends in the range of 16 to 20 inches. Each of the slots may extend through a first side surface of the respective first and second rail portions and through a second side surface of the respective first and second rail portions. The bolts may extend through each of the slots from the first side surface of the respective first and second rail portions, through a cavity defined by respective first and second rail portions, and through a second side surface of the respective first and second rail portions. The upper surface may be configured to allow a user to stand on the platform.

The one or more legs may be configured to extend in the first direction proximate to the outside surface of the structure when the ladder is mounted to the structure. Each of the plurality of rungs may define opposed ends that are connected to respective side rails. The ladder may include an extension portion configured to be mounted to at least one of the plurality of rungs, the first side rail, and/or the second side rail. The extension portion may include side rails, a plurality of rungs, one or more second arms, and one or more connectors. The side rails of the extension portion may extend in the first direction when the extension is mounted to the at least one of the first plurality of rungs. The side rails of the extension portion may be parallel. The plurality of rungs of the extension portion may extend between the side rails of the extension portion. The one or more arms of the extension portion may be configured to extend in the second direction. When the ladder is mounted to a structure, the one or more arms of the extension portion may be configured to abut the inside surface of the structure. The one or more connectors may be configured to engage the at least one of the plurality of rungs. The one or more arms of the extension portion may be adjustable in the second direction to a plurality of lengths. The one or more arms of the extension portion may define a stationary portion and a translating portion. The translating portion may be configured to translate with respect to the stationary portion. Each of the one or more arms of the portion may include a lock configured to secure the translating portion to the stationary portion at each of the plurality of lengths.

The ladder may include a platform. The platform may define an upper surface between the first and second rails and the one or more legs. The upper surface may be configured to enable a user to stand and access the plurality of rungs when the ladder is mounted to the structure. The platform may define a lower surface that is configured to abut the structure when the ladder is mounted to the structure. The ladder may include a handrail that extends above the platform when the ladder is mounted to the structure.

### BRIEF DESCRIPTION OF THE DRAWINGS

FIG. 1 is a front perspective view of an example ladder.

FIG. 2 is a front perspective view showing details of the locking mechanism of the example ladder shown in FIG. 1.

FIG. 3 is a side view of the example ladder shown in FIG. 1

FIG. 4A is a detailed side view of the example ladder shown in FIG. 1 in the mounting position.

FIG. 4B is a detailed side view of the example ladder shown in FIG. 1 in the secured position.

FIG. 5 is a rear view of the example ladder shown in FIG. 1.

FIG. 6 is a front perspective view of an extension portion configured to be mounted to the example ladder shown in FIG. 1 and/or the example ladder shown in FIG. 9.

FIG. 7 is a detailed perspective view showing details of an adjustable arm of the extension portion shown in FIG. 6.

FIG. 8 is a detailed perspective view showing details of a connector of the extension portion shown in FIG. 6.

FIG. 9 is a front perspective view of another example ladder.

FIG. 10 is a side view of the example ladder shown in FIG. 9.

FIG. 11 is a detailed side view of the example ladder shown in FIG. 9, showing details of a triangular lift point.

FIG. 12A is a detailed cross-section view of the example ladder shown in FIG. 9, showing details of connection of the adapter to the platform.

FIG. 12B is a detailed side view of the example ladder shown in FIG. 9, showing details of the adjustment assembly.

FIG. 13A is a front perspective view of a slotted channel of the example ladder shown in FIG. 9.

FIG. 13B is a top view of the slotted channel shown in FIG. 13A.

FIG. 13C is a side view of the slotted channel shown in FIG. 13A.

FIG. 14A is a front perspective view of an adjustment assembly of the example ladder shown in FIG. 9.

FIG. 14B is a side view of the adjustment assembly shown in FIG. 14A.

FIG. 14C is a front view of a plate of the adjustment assembly shown in FIG. 14A.

### DETAILED DESCRIPTION

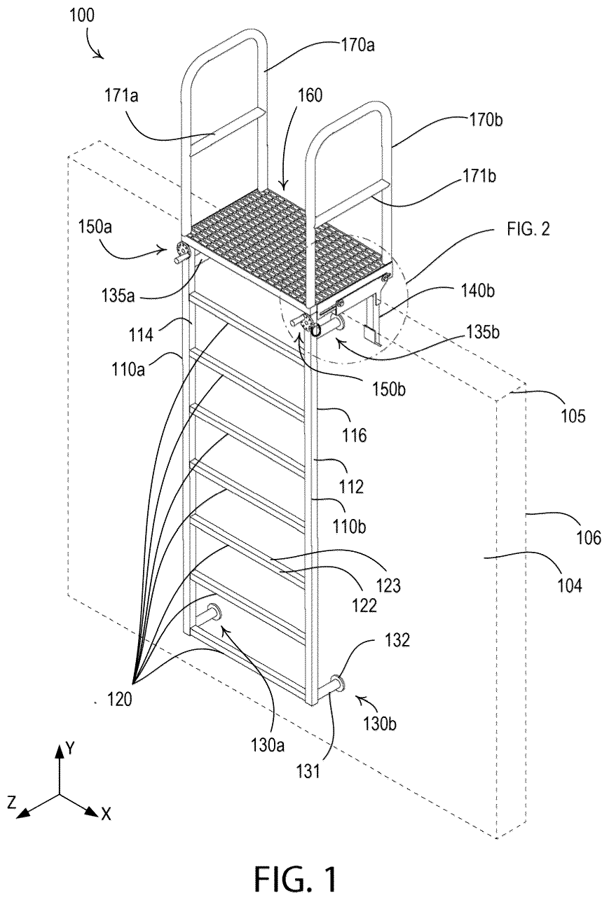

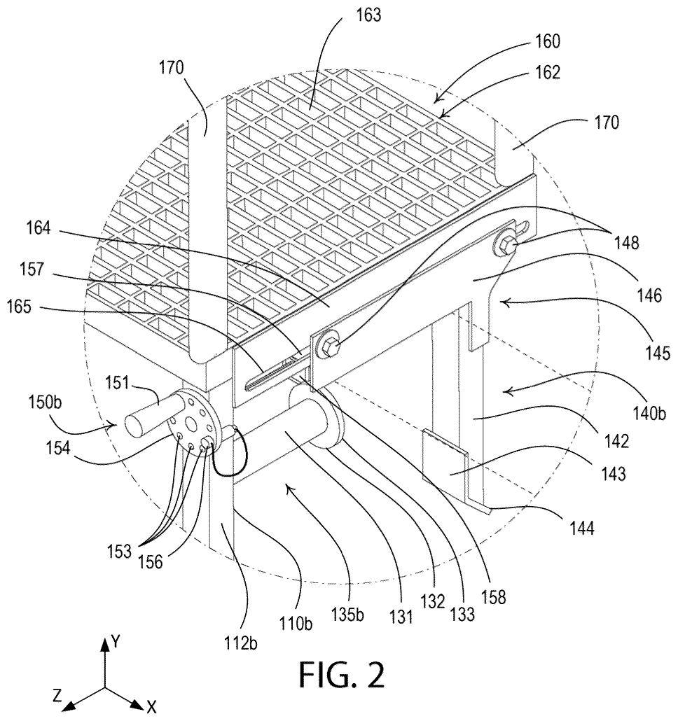

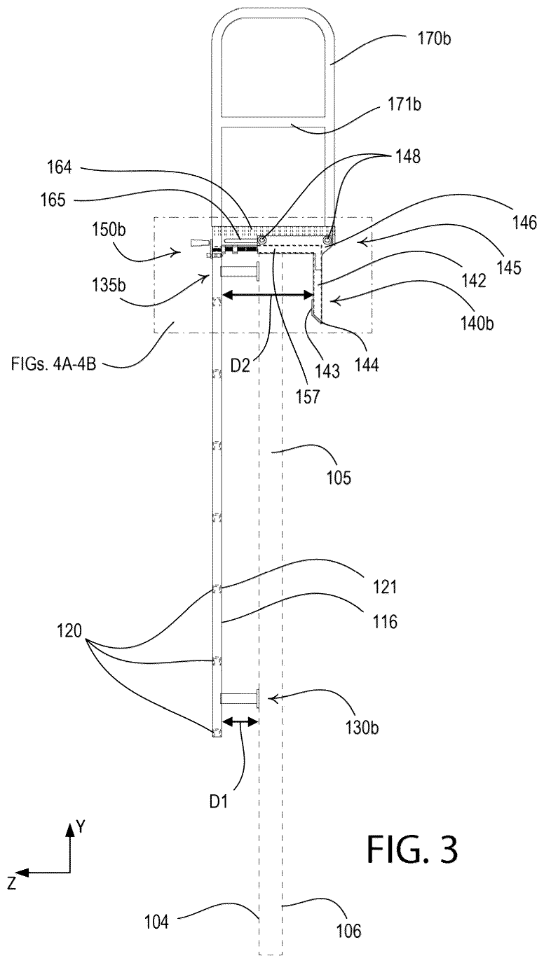

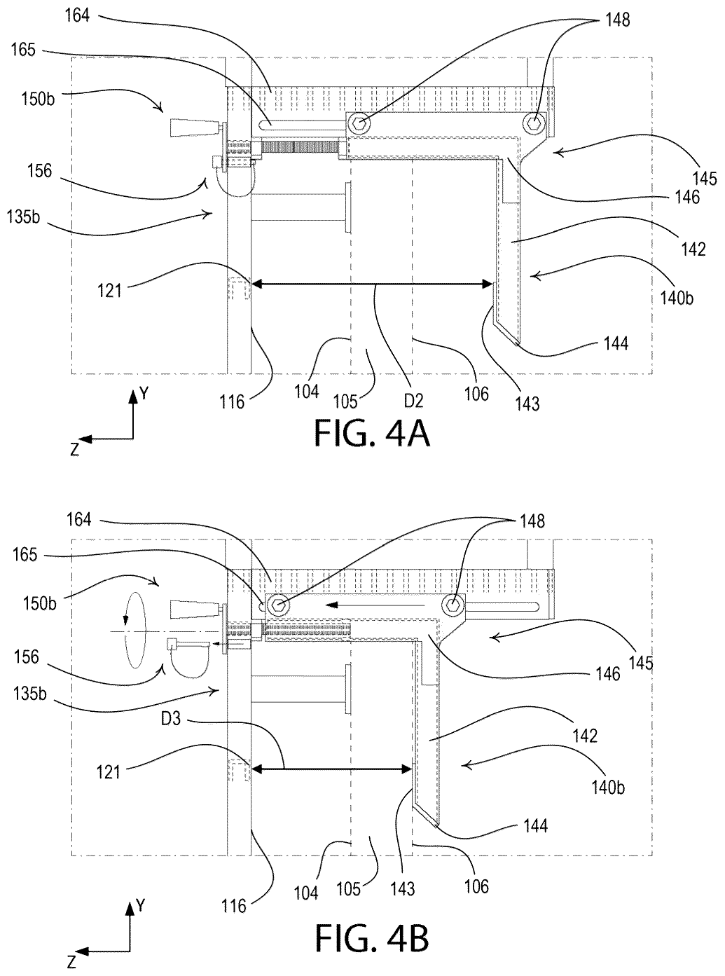

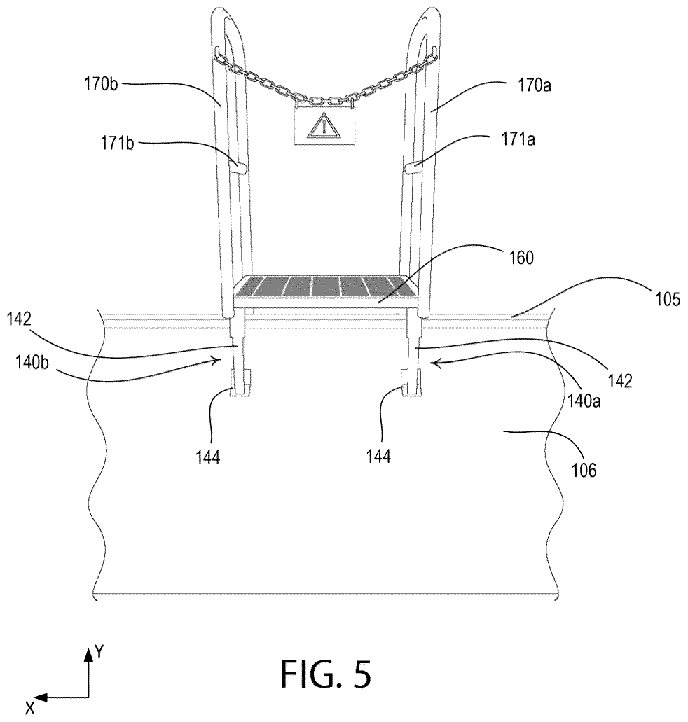

FIGS. 1-5 depict an example ladder 100. FIG. 1 is a front perspective view of the example ladder 100. FIG. 2 is a front perspective detailed view of the example ladder 100. FIG. 3 is a side view of the example ladder 100. FIG. 4A is a detailed side view of the example ladder 100. FIG. 4B is another detailed side view of the example ladder 100. FIG. 5 is a rear view of the example ladder 100.

The ladder 100 may be capable of being mounted to a structure 105 and may allow users to traverse (e.g., ascend or descend) the structure 105. The structure 105 may be a wall of a trench shoring system. For example, the ladder 100 may be configured to be mounted to a wall of a trench shoring system that is within a ground trench. The ladder 100 may be configured to be secured to the wall of the trench shoring system and allow a user to access the ground trench without the ladder 100 obstructing work within the trench. An outside surface 106 of the structure 105 may be buried (e.g., with dirt, gravel, debris, etc.) or otherwise inaccessible. The ladder 100 may be mounted to the structure 105, even when the outside surface 106 of the structure 105 is buried or inaccessible.

The ladder 100 may comprise a first side rail 110a, a second side rail 110b, a plurality of rungs 120, an arm (e.g., such as the arms 130a, 130b, 135a, 135b), a leg (e.g., such as the legs 140a 140b), and a locking mechanism (e.g., such as the locking mechanisms 150a, 150b). The locking mechanisms 150a, 150b may be referred to as adjustment assemblies. The ladder 100 may further comprise a handrail 160 and a platform 170. The ladder 100 (e.g., the components of the ladder 100) may be made from one or more (e.g., a variety of) materials, for example, such as plastic, rubber, metal, metal coated rubber, composites, fiberglass, wood, and/or the like. A coating (e.g., such as paint, acrylic, polyurethane, epoxy, etc.) may be applied to the ladder 100 (e.g., one or more components of the ladder 100).

The first side rail 110a and second side rail 110b may extend in a first direction (e.g., the y direction). Each of the first and second side rails 110a 110b may define an outer surface 112, an inner surface 114, and a rear surface 116. The first side rail 110a and the second side rail 110b may be parallel to one another. The first side rail 110a and second side rail 110b may define, for example, circular cross-sections, elliptical cross-sections, rounded cross-sections, polygonal cross-sections, and/or the like.

Each of the plurality of rungs 120 may extend between the first side rail 110a and the second side rail 110b. The plurality of rungs 120 may define opposed ends that are connected to the first rail 110a or the second rail 110b. For example, each of the plurality of rungs 120 may extend from the respective inner surfaces 114 of the first and second side rails 110a, 110b. Each of the plurality of rungs 120 may define, for example, a circular cross-section, an elliptical cross-section, a rounded cross-section, a polygonal cross-section, and/or the like. Each of the plurality of rungs 120 may be coated, in part or in full, with a high friction material (e.g., an anti-slip coating) to improve user safety. Each of the plurality of rungs may define a respective rear surface 121 and a respective front surface 122. Although the plurality of rungs 120 are shown in FIG. 1 as an upper surface 123 that is solid, it should be appreciated that the upper surface 123 of each of the plurality of rungs 120 may be grated, slotted, serrated, and/or perforated.

The arms 130a, 130b, 135a, 135b may be configured to abut the structure 105 (e.g., the inner surface 104) and may stabilize the ladder 100 against the structure 105. The arms 130a, 130b, 135a, 135b may extend in a second direction (e.g., the z direction). In an example, the second direction may be substantially orthogonal to the first direction. The arms 130a, 130b, 135a, 135b may be configured, such that when the ladder 100 is mounted to a structure (e.g., such as the structure 105), the arms 130a, 130b, 135a, 135b abut the structure and maintain a predetermined distance D1 between the plurality of rungs 120 and the structure. For example, the arms 130a, 130b, 135a, 135b may be configured to such that the side rails 110a, 110b are substantially parallel with the inner surface 104 of the structure 105. Each of the arms 130a, 130b, 135a, 135b may comprise a member 131 and a flat portion 132. The member 131 may define a circular cross-section, for example, as shown in the figures. Although the figures show the member 131 as having a circular cross-section, it should be appreciated that the member 131 may define other cross-sections (e.g., such as rectangular, polygonal, etc.). The predetermined distance D1 may be measured between a respective rear surface 121 of each of the plurality of rungs 120 and the inner surface 104 of the structure 105. The arms 130a, 130b, 135a, 135b may be adjustable to a plurality of lengths. It should be appreciated that although the figures show the ladder 100 having four arms 130a, 130b, 135a, 135b, the ladder 100 may comprise more or less than four arms.

The legs 140a, 140b may be configured to abut the structure 105 (e.g., the outer surface 106) and may stabilize the ladder 100 against the structure 105. The legs 140a, 140b may be configured to extend proximate to the outer surface 106 of the structure 105 when the ladder 100 is mounted to the structure 105. For example, the legs 140a. 140b may extend in the first direction (e.g., the y-direction). The legs 140a, 140b may be configured to hinder movement of the plurality of rungs 120 (e.g., movement in the second direction and/or the first direction). Each of the legs 140a, 140b may define a contact surface 143 that is configured to abut the structure 105 (e.g., the outer surface 106) when the ladder 100 is mounted to the structure 105. Each of the legs 140a, 140b may comprise a leg portion 142 and a foot portion 144. The foot portion 144 may define the contact surface 143.

The legs 140a, 140b may be attached to an adapter 145 that is configured to slidingly secure the legs 140a, 140b to the ladder 100. The adapter 145 may define a coupling 146 and one or more fasteners 148. The legs 140a, 140b may extend from the coupling 146. The coupling 146 may be configured to rest on the structure 105 (e.g., an upper surface 107 of the structure 105). The adapter 145 may be configured to be adjusted (e.g., in the z-direction) between the mounting position and the secured position to allow the ladder 100 to be mounted and secured to structures having a plurality of different thicknesses.

The locking mechanisms 150a, 150b may be configured to be operated to secure the ladder 100 to a structure (e.g., the structure 105). For example, the locking mechanisms 150a, 150b may be adjustment assemblies that are configured to adjust the legs 140a, 140b to abut the structure 105 (e.g., the outer surface 106) when the ladder 100 is mounted to the structure 105 to prevent movement of the plurality of rungs 120 with respect to the structure 105. Although the locking mechanisms 150a, 150b are shown in the Figures as being configured to be operated proximate to the inner surface 104 of the structure 106, it should be appreciated that the locking mechanisms 150a, 150b may be alternatively or additionally configured to be operated proximate to the outer surface 106 of the structure 105.

The ladder 100 may further comprise a platform 160. The platform 160 may extend in the z-direction, for example, between the legs 140a, 140b and the side rails 110a, 110b. The platform 160 may define a lower surface 161 that is configured to be proximate to the structure 105 when the ladder 100 is mounted to the structure 105. The platform 160 may define an upper surface 162 that is configured to allow the user to stand on the platform 160, and/or mount or dismount the ladder 100. The upper surface 162 may include one or more high-friction materials (e.g., an anti-slip coating) to improve user safety. Additionally or alternatively, the upper surface 162 may include grating 163 (e.g., serrated metal grating). The platform 160 may comprise rail portions 164 on opposed sides of the platform 160 (e.g., the upper surface 162). Each of the rail portions 164 may include a slot 165. The rail portion 164 may engage with the trolley portion 142 of the leg 140. One or more bolts 148 (e.g., such as trolley bolts) may engage with the slot 165 to facilitate adjustability and movement of the legs 140a, 140b relative to the platform 160. Each of the slots 165 may comprise two portions that extend in a range of 5 to 8 inches and are spaced apart in the range of 3 to 5 inches. Alternatively, each of the slots 165 may comprise one portion that extends in the range of 16 to 20 inches (e.g., 17.875 inches). Each of the slots 165 may be configured to receive one or more bolts 148, for example, to enable adjustment of the distance D2 between the legs 140a, 140b and the side rails 110a, 110b. The distance D2 between the legs 140a, 140b and the side rails 110a, 110b (e.g., and/or the arms 135a, 135b) may be adjusted based on the sliding attachment of the one or more bolts 148 in the respective slot 165. In examples, the one or more bolts 148 may be slidingly secured to the platform 160.

Each of the locking mechanisms 150a, 150b may comprise a hand crank 151 and a bolt 152. The hand crank 151 may be configured to be operated (e.g., rotated) by a user to secure the ladder 100 to the structure 105. The hand crank 151 may be secured to a plate 154 that is coupled to the bolt 152 such that rotations of the hand crank 151 are transferred to the bolt 152. The plate 154 may define a plurality of holes 155 therethrough. The bolt 152 may be operably coupled to the adapter 145 such that operation of the locking mechanism 150a, 150b causes translation of the adapter 145 with respect to the slot 165. The hand crank 151 may be configured to be operated to adjust the ladder 100 between a mounting position (e.g., as shown in FIG. 4A) and an secured position (e.g., as shown in FIG. 4B). When the ladder 100 is in the secured position, the arms 130a, 130b, 135a, 135b may be configured to abut the inner surface 104 of the structure 105.

The locking mechanism 150a, 150b may comprise a box tube 157 that is configured to accept a bolted carriage 158. The box tube 157 may define a metal tube with a rectangular (e.g., square) cross-section. The bolted carriage 158 may be configured to slide back and forth within the box tube 157 as the bolt 152 is operated. The box tube 156 may be configured to slidingly receive the bolted carriage 158. The bolted carriage 158 may define a rectangular (e.g., square) cross-section, for example, to correspond with the geometry of the box tube 157. The bolted carriage 158 may be operably coupled to the bolt 152 to adjust the one or more legs 140a, 140b to secure the ladder 100 to the structure. For example, the bolted carriage 158 may be configured to translate within the box tube 157 (e.g., in the z-direction) to operate the ladder 100 between the mounting position and the secured position. The adapter 145 may be configured to move relative to the platform 160 (e.g., in the z-direction) when one or more of the locking mechanisms 150a, 150b are operated. The one or more bolts 148 in the slot 165 may be configured to guide the adapter 145 (e.g., in the z-direction) between the mounting position and the secured position.

When the ladder 100 is in the mounting position, the legs 140a, 140b may be spaced a second distance D2 from the side rails 110a, 110b such that the ladder 100 can be mounted to a structure (e.g., such as the structure 105). When the ladder 100 is in the secured position, the legs 140a, 140b may be spaced a third distance D3 from the side rails 110a, 110b and may abut an outer surface (e.g., the outer surface 106) of the structure. For example, the arms 130a, 130b, 135a, 135b and the legs 140a, 140b may be configured to clamp the structure 105 when the ladder 100 is in the secured position. The arms 130a, 130b, 135a, 135b may abut the inner surface 104 of the structure 105 and the legs 140a, 140b may abut the outer surface 106 of the structure 105 when the ladder 100 is in the secured position. The second distance D2 may be greater than the third distance D3.

Each of the locking mechanisms 150a, 150b may comprise a fastener 156. The fastener 156 may be configured to engage with one of the plurality of holes 153 in the disk 154, for example, to prevent operation of the respective one of the locking mechanisms 150a, 150b. For example, the fastener 156 may abut the respective outer surface 112a, 112b of the side rails 110a, 110b to prevent operation of the locking mechanisms 150a, 150b. It should be appreciated that the locking mechanisms 150a, 150b may be implemented by alternative means. For example, the locking mechanisms 150a, 150b may comprise a clamp or a vise.

The ladder 100 may further comprise one or more handrails (e.g., such as the handrails 170a, 170b). The handrails 170a, 170b may extend above the platform 160 when the ladder 100 is mounted to a structure. The handrails 170a, 170b may define a circular cross-section, an elliptical cross-section, a rounded cross-section, a polygonal cross-section, and/or the like. Each of the handrails 170a, 170b may include a respective support member 171a, 171b that are configured to provide stability and support to the respective handrails 170a, 170b.

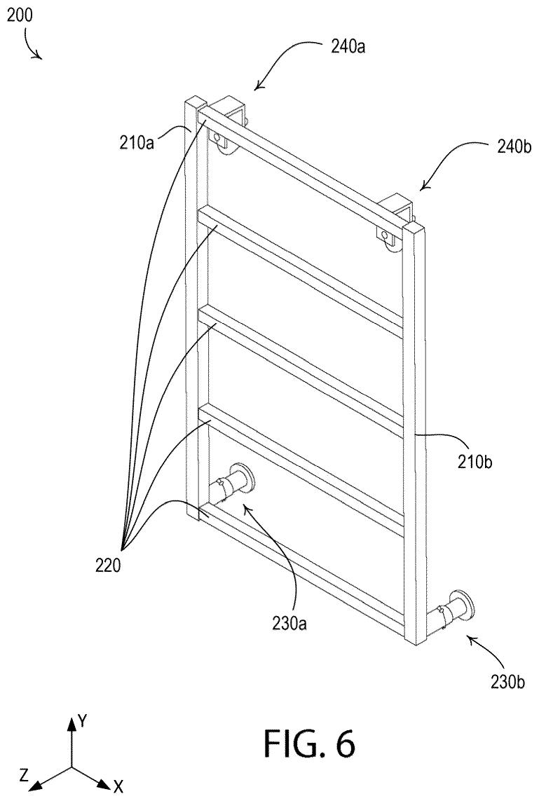

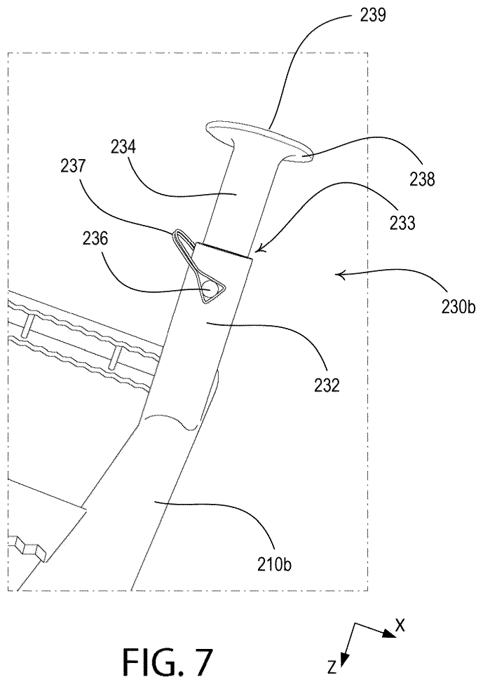

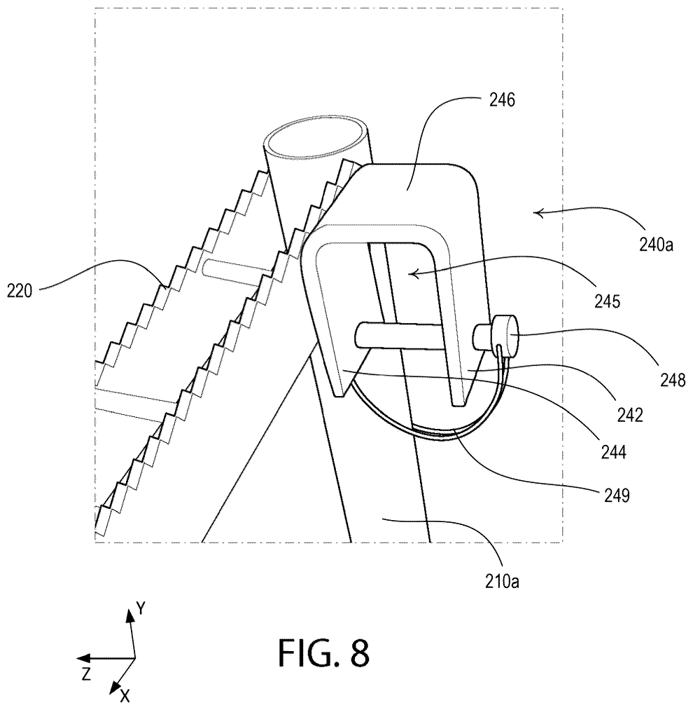

FIGS. 6-8 depict an example extension portion 200 for use with the ladder 100. FIG. 6 is a front perspective view of the extension portion 200. FIG. 7 is a detailed view of the extension portion 200. FIG. 8 is another detailed view of the extension portion 200. For example, the ladder 100 may include the extension portion 200. The extension portion 200 may be configured to be mounted to at least one of the plurality of rungs 120 of the ladder 100. Additionally or alternatively, the extension portion 200 may be configured to be mounted to the first side rail 110a and/or the second side rail 110b. The extension portion 200 may be configured to extend the height of the ladder 100. The extension portion 200 may define side rails 210a, 210b that extend substantially in the y-direction when the extension portion 200 is mounted to the at least one of the plurality of rungs 120. The side rails 210a, 210b of the extension portion 200 may be parallel to one another. The extension portion 200 may include a plurality of rungs 220. The plurality of rungs 220 may extend between the side rails 210a, 210b of the extension portion 200.

The extension portion 200 may comprise one or more arms (e.g., such as the arms 230a, 230b). The arms 230a, 230b may extend from respective ones of the side rails 210a, 210b. The arms 230a, 230b may extend in the z-direction. When the ladder 100 is mounted to a structure (e.g., such as the structure 105) and the extension portion 200 is mounted to the at least one of the plurality of rungs 120, the arms 230a, 230b may be configured to abut the structure (e.g., such as the inner surface 104 of the structure 105).

The arms 230a, 230b may be adjustable (e.g., in the z-direction) to a plurality of lengths. For example, the arms 230a, 230b may be adjustable to enable the plurality of rungs 220 to remain substantially parallel with the plurality of rungs 120. The arms 230a, 230b may stabilize the extension portion 200 against the structure, for example, even when the plurality of rungs 220 are misaligned (e.g., slightly misaligned) with the plurality of rungs 120. For example, the arms 230a, 230b may be adjustable to create pitch and/or prevent swaying or shifting of the extension portion 200 from the structure. When extension portions (e.g., such as the extension portion 200) are added, the connection between the extension portion(s) and the respective rung may create an angle such that a lower end of the extension portion(s) are spaced further away from the structure than an upper end of the extension portion(s). The adjustability of the arms 230a, 230b may be configured to accommodate this change in angle.

Each of the arms 230a, 230b may comprise a stationary portion 232 and a translating portion 234. The translating portion 234 may be configured to translate with respect to the stationary portion 232. The stationary portion 232 may extend from a respective one of the side rails 210a, 210b. The stationary portion 232 may define a cavity 233 that is configured to receive at least a portion of the translation portion 234. The translating portion 234 may define a base portion 238 that is distal from the stationary portion 232. The base portion 238 may define a contact surface 239 that is configured to abut the structure (e.g., the inner surface 104 of the structure 105). Each of the arms 230a, 230b may comprise a lock 236 configured to secure the translating portion 234 to the stationary portion 232 at each of the plurality of lengths. The lock 236 may be a pin that is received through corresponding holes in the stationary portion 232 and the translating portion 234. The lock 236 may be attached to the stationary portion 232 via a lanyard 237.

The extension portion 200 may comprise one or more connectors (e.g., connectors 240a, 240b). The connectors 240a, 240b may be configured to engage (e.g., receive) the at least one of the plurality of rungs 120. For example, the connectors 240a, 240b may be configured to couple the extension portion 200 to the at least one of the plurality of rungs 120 (e.g., a main portion of the ladder 100). Each of the connectors 240a, 240b may define a U-shaped cross-section. It should be appreciated that the connectors 240a, 240b are not limited to this cross-sectional geometry, the connectors 240a, 240b may instead define alternate cross-sections (e.g., such as a V-shaped cross section, a semi-circular cross-section, etc.). Each of the connectors 240a, 240b may define a front wall 242, a rear wall 244, and an upper wall 246. The front wall 242, the rear wall 244, and the upper wall 246 may define a channel 245 that is configured to receive the at least one of the plurality of rungs 120.

It should be appreciated that although one example extension portion 200 is shown in the figures, the extension portion 200 is not limited to this configuration and size. Instead, the extension portion 200 may be various lengths having any number of rungs 220. In addition, more than one extension portion 200 can be used to further extend the length of the ladder 100.

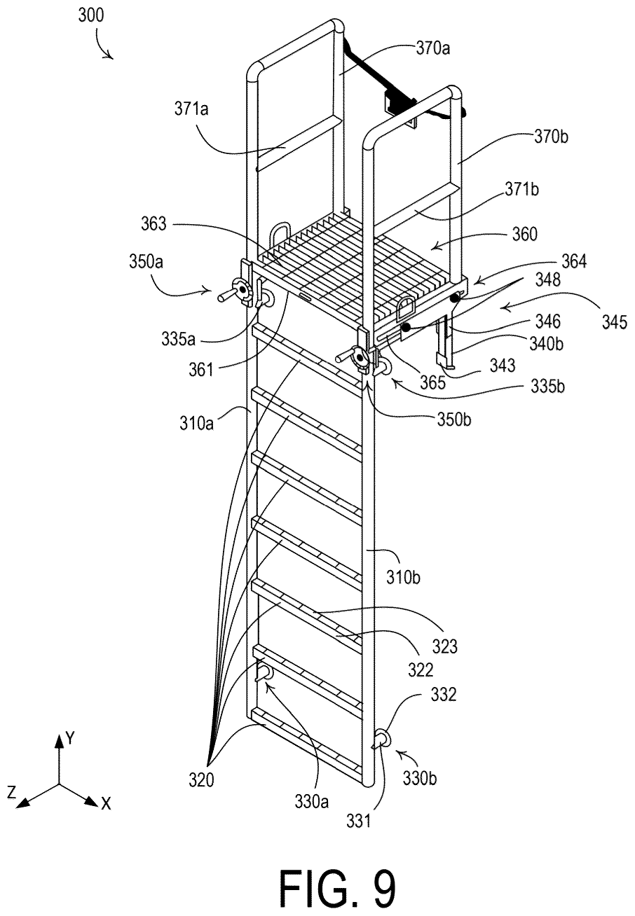

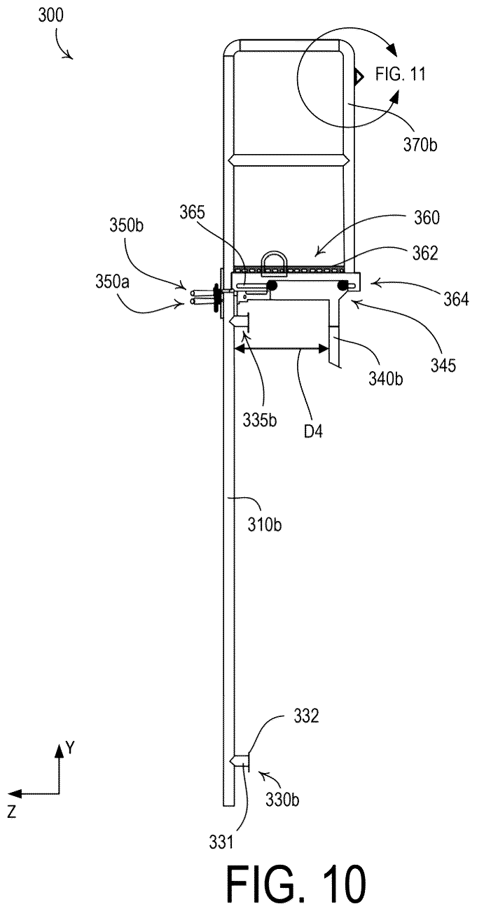

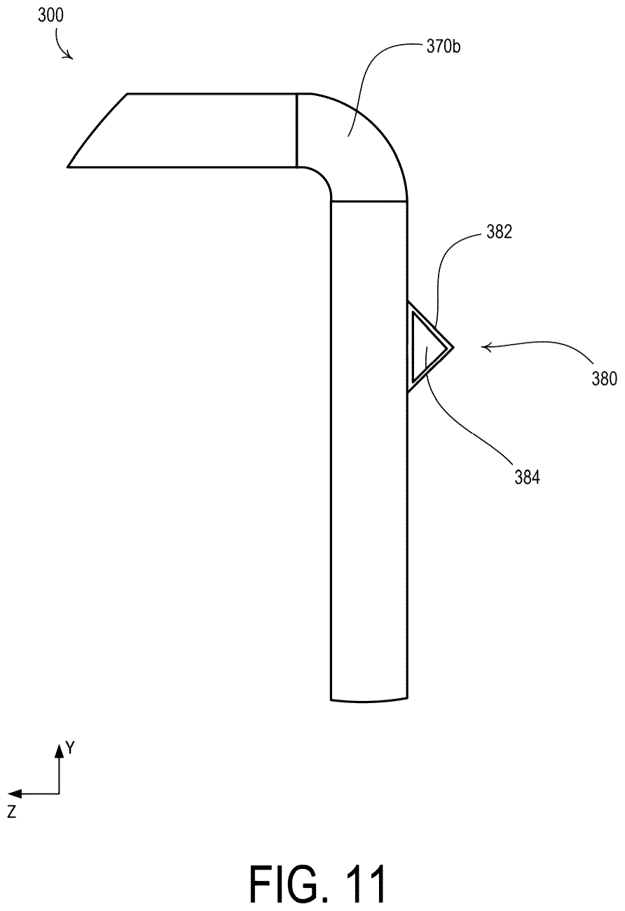

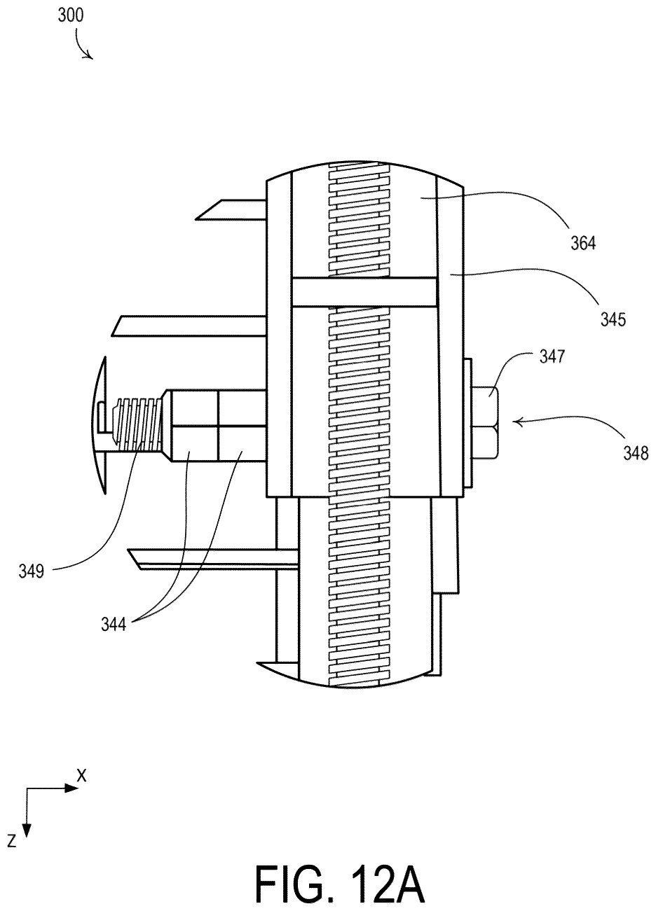

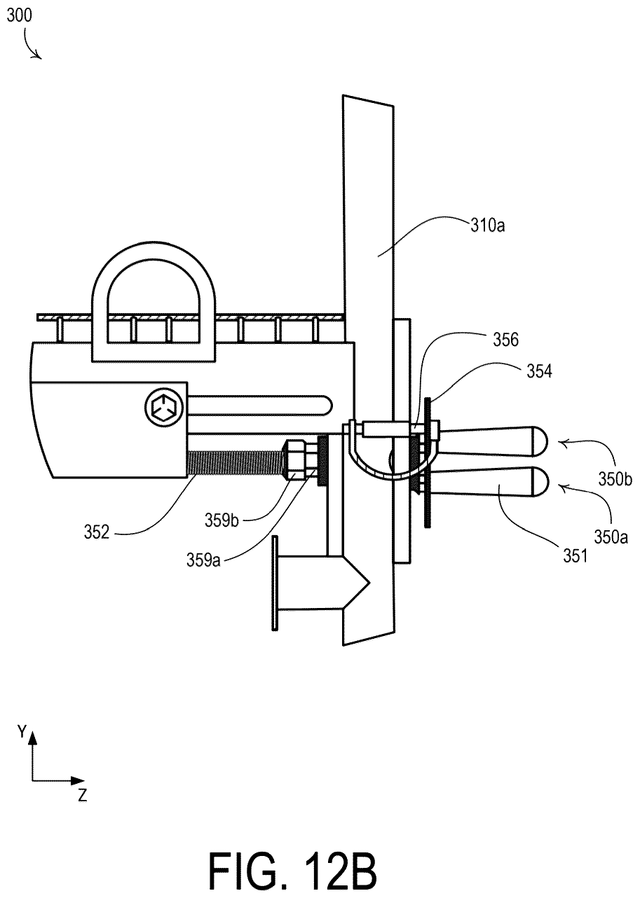

FIGS. 9-12B depict another example ladder 300. FIG. 9 is a front perspective view of the example ladder 300. FIG. 10 is a side view of the example ladder 300. FIG. 11 is a detailed sided view of the example ladder 300 showing lifting points 302. FIG. 12A is a detailed view of the example ladder 300 showing bolts 148 received through a respective one of the slots 365. FIG. 12B is a detailed view of the example ladder 300 showing the adjustment assembly 350a. The ladder 300 may be capable of being mounted to a structure (e.g., such as the structure 105) and may allow users to traverse (e.g., ascend or descend) the structure. The structure may be a wall of a trench shoring system. For example, the ladder 300 may be configured to be mounted to a wall of a trench shoring system that is within a ground trench. The ladder 300 may be configured to be secured to the wall of the trench shoring system and allow a user to access the ground trench without the ladder 300 obstructing work within the trench. An outside surface of the structure may be buried (e.g., with dirt, gravel, debris, etc.) or otherwise inaccessible. The ladder 300 may be mounted to the structure, even when the outside surface of the structure is buried or inaccessible.

The ladder 300 may comprise a first side rail 310a, a second side rail 310b, a plurality of rungs 320, one or more arms (e.g., such as the arms 330a, 330b, 335a, 335b), one or more legs (e.g., such as the legs 340a 340b), and one or more adjustment assemblies (e.g., such as the adjustment assemblies 350a, 350b). The adjustment assemblies 350a, 350b may be similar to the locking mechanisms 150a, 150b and may be referred to as locking mechanisms. The ladder 300 may further comprise a handrail 360 and a platform 370. The ladder 300 (e.g., the components of the ladder 300) may be made from one or more (e.g., a variety of) materials, for example, such as plastic, rubber, metal, metal coated rubber, composites, fiberglass, wood, and/or the like. A coating (e.g., such as paint, acrylic, polyurethane, epoxy, etc.) may be applied to the ladder 300 (e.g., one or more components of the ladder 300).

The first side rail 310a and second side rail 310b may extend in a first direction (e.g., the y direction). The first side rail 310a and the second side rail 310b may be parallel to one another. The first side rail 310a and second side rail 310b may define, for example, circular cross-sections, elliptical cross-sections, rounded cross-sections, polygonal cross-sections, and/or the like.

Each of the plurality of rungs 320 may extend between the first side rail 310a and the second side rail 310b. The plurality of rungs 320 may define opposed ends that are connected to the first rail 310a or the second rail 310b. For example, each of the plurality of rungs 320 may extend from respective inner surfaces of the first and second side rails 310a, 310b. Each of the plurality of rungs 320 may define, for example, a circular cross-section, an elliptical cross-section, a rounded cross-section, a polygonal cross-section, and/or the like. Each of the plurality of rungs 320 may be coated, in part or in full, with a high friction material (e.g., an anti-slip coating) to improve user safety. Each of the plurality of rungs may define a respective rear surface 321 and a respective front surface 322. Each of the plurality of rungs 320 may define an upper surface 123 that is solid, grated, slotted, serrated, and/or perforated.

The arms 330a, 330b, 335a, 335b may be configured to abut the structure (e.g., the inner surface 104 of the structure 105) and may stabilize the ladder 300 against the structure. The arms 330a, 330b, 335a, 335b may extend in a second direction (e.g., the z direction). In an example, the second direction may be substantially orthogonal to the first direction. The arms 330a, 330b, 335a, 335b may be configured, such that when the ladder 300 is mounted to a structure (e.g., such as the structure 105), the arms 330a, 330b, 335a, 335b abut the structure and maintain a predetermined distance (e.g., such as the distance D1) between the plurality of rungs 320 and the structure. For example, the arms 330a, 330b, 335a, 335b may be configured to such that the side rails 310a, 310b are substantially parallel with the structure (e.g., the inner surface 104 of the structure 105). Each of the arms 330a, 330b, 335a, 335b may comprise a member 331 and a flat portion 332. The member 331 may define a circular cross-section, for example, as shown in the figures. Although the figures show the member 331 as having a circular cross-section, it should be appreciated that the member 331 may define other cross-sections (e.g., such as rectangular, polygonal, etc.). The predetermined distance D1 may be measured between a respective rear surface 321 of each of the plurality of rungs 320 and the structure (e.g., the inner surface 104 of the structure 105). The arms 330a, 330b, 335a, 335b may be adjustable to a plurality of lengths. It should be appreciated that although the figures show the ladder 300 having four arms 330a, 330b, 335a, 335b, the ladder 300 may comprise more or less than four arms.

The legs 340a, 340b may be configured to abut the structure (e.g., such as the outer surface 106 of the structure 105) and may stabilize the ladder 300 against the structure. The legs 340a, 340b may be configured to extend proximate to the outer surface of the structure when the ladder 300 is mounted to the structure. For example, the legs 340a. 340b may extend in the first direction (e.g., the y-direction). The legs 340a, 340b may be configured to hinder movement of the plurality of rungs 320 (e.g., movement in the second direction and/or the first direction). Each of the legs 340a, 340b may define a contact surface 343 that is configured to abut the structure (e.g., the outer surface 106 of the structure 105) when the ladder 300 is mounted to the structure.

The legs 340a, 340b may be attached to an adapter 345 that is configured to slidingly secure the legs 340a, 340b to the ladder 300. The adapter 345 may define a coupling 346 and one or more bolts 348. The one or more bolts 348 may be trolley bolts. The legs 340a, 340b may extend from the coupling 346. The coupling 346 may be configured to rest on the structure (e.g., such as the upper surface 107 of the structure 105). The adapter 345 may be configured to be adjusted (e.g., in the z-direction) between the mounting position and the secured position to allow the ladder 300 to be mounted and secured to structures having a plurality of different thicknesses.

The adjustment assemblies 350a, 350b may be configured to be operated to secure the ladder 300 to the structure (e.g., the structure 105). For example, the adjustment assemblies 350a, 350b may be configured to adjust the position of the legs 340a, 340b to abut the structure (e.g., the outer surface 106) when the ladder 300 is mounted to the structure to prevent movement of the plurality of rungs 320 with respect to the structure. Although the adjustment assemblies 350a, 350b are shown in the Figures as being configured to be operated proximate to the plurality of rungs 320 (e.g., and proximate to the inner surface 104 of the structure 105), it should be appreciated that the adjustment assemblies 350a, 350b may be alternatively or additionally configured to be operated proximate to the legs 340a, 340b (e.g., and proximate to the outer surface 106 of the structure 105).

The ladder 300 may further comprise a platform 360. The platform 360 may extend in the z-direction, for example, between the legs 340a, 340b and the side rails 310a, 310b. The platform 360 may define a lower surface 361 that is configured to be proximate to (e.g., abut) the structure when the ladder 300 is mounted to the structure. The platform 360 may define an upper surface 362 that is configured to allow the user to stand on the platform 360, and/or mount or dismount the ladder 300. The upper surface 362 may include one or more high-friction materials (e.g., an anti-slip coating) to improve user safety. Additionally or alternatively, the upper surface 362 may include grating 363 (e.g., serrated metal grating).

The ladder 300 may further comprise one or more handrails (e.g., such as the handrails 370a, 370b). The handrails 370a, 370b may extend above the platform 360 when the ladder 300 is mounted to a structure. The handrails 370a, 370b may define a circular cross-section, an elliptical cross-section, a rounded cross-section, a polygonal cross-section, and/or the like. Each of the handrails 370a, 370b may include a respective support member 371a, 371b that are configured to provide stability and support to the respective handrails 370a, 370b. The ladder 300 may define one or more lift points 380 that are configured to receive various hook sizes to enable lifting ladder 300 by machine as well as 2 man lifts with tools. The lift points 380 may extend from the handrails 370a, 370b. Each of the lift points 380 may define a frame 382 and an aperture 384. The frame 382 and/or the aperture 384 may be triangular-shaped.

The platform 360 may comprise rail portions 364 on opposed sides of the platform 360 (e.g., the upper surface 362). Each of the rail portions 364 may include a slot 365. The rail portion 364 may engage with the adapter 345. The one or more bolts 348 (e.g., such as trolley bolts) may engage with the slot 365 to facilitate adjustability and movement of the legs 340a, 340b relative to the platform 360. Each of the slots 365 may be configured to receive one or more bolts 348, for example, to enable adjustment of the distance D4 between the legs 340a, 340b and the side rails 310a, 310b. The distance D4 between the legs 340a, 340b and the side rails 310a, 310b (e.g., and/or the arms 335a, 335b) may be adjusted based on the sliding attachment of the one or more bolts 348 in the respective slot 365. For example, the one or more bolts 348 may be slidingly secured to the platform 360 via the slots 365. The ladder 300 may comprise one or more nuts 344 that are configured to engage the bolts 348. For example, each of the bolts 348 may define a head 347 and a threaded portion 349. The one or more nuts 344 may be received by the threaded portion 349 of the bolts 348 to enable sliding attachment of the adapter 345 to the platform 360. For example, the head 347 may be located on a first side of the rail portion 364 and the nuts 344 may be located on a second side of the rail portion 364.

The adjustment assemblies 350a, 350b may be operably coupled to the adapter 345 such that operation of one or more of the adjustment assemblies 350a, 350b causes translation of the adapter 345 with respect to the slot 365. The adapter 345 may be configured to move relative to the platform 360 (e.g., in the z-direction) when one or more of the adjustment assemblies 350a, 350b are operated. One or more of the adjustment assemblies 350a, 350b may be configured to be operated to adjust the ladder 300 between a mounting position (e.g., as shown in FIG. 4A) and a secured position (e.g., as shown in FIG. 4B). The one or more bolts 348 in the slot 365 may be configured to guide the adapter 345 (e.g., in the z-direction) between the mounting position and the secured position. When the ladder 300 is in the secured position, the arms 330a, 330b, 335a, 335b may be configured to abut the structure (e.g., such as the inner surface 104 of the structure 105).

When the ladder 300 is in the mounting position, the legs 340a, 340b may be spaced a second distance (e.g., such as distance D2 shown in FIG. 4A) from the side rails 310a, 310b such that the ladder 300 can be mounted to a structure (e.g., such as the structure 105). When the ladder 300 is in the secured position, the legs 340a, 340b may be spaced a third distance (e.g., such as distance D3 shown in FIG. 4B) from the side rails 310a, 310b and may abut an outer surface (e.g., the outer surface 106) of the structure. For example, the arms 330a, 330b, 335a, 335b and the legs 340a, 340b may be configured to clamp the structure when the ladder 300 is in the secured position. The arms 330a, 330b, 335a, 335b may abut the inner surface (e.g., such as inner surface 104) of the structure and the legs 340a, 340b may abut the outer surface (e.g., such as the outer surface 106) of the structure when the ladder 300 is in the secured position. The second distance may be greater than the third distance.

Each of the adjustment assemblies 350a, 350b may comprise a hand crank 351 and a bolt 352. The hand crank 351 may be configured to be operated (e.g., rotated) by a user to secure the ladder 300 to the structure. The hand crank 351 may be secured to a plate 354 that is coupled to the bolt 352 such that rotations of the hand crank 351 are transferred to the bolt 352. Each of the adjustment assemblies 350a, 350b may include one or more nuts (e.g., such as nuts 359a, 359b). The one or more nuts may include a hex nut 359a and a locknut 359b. The one or more nuts 359a, 359b may be configured to enable adjustment of the adjustment assemblies 350a, 350b. The lock nut 359b may enable a smoother rotation of the thread of the bolt 352 as the hand crank 351 is turned. The lock nut 359b may prevent and/or eliminate binding of the thread and oval thread connector. The lock nut 359b may allow the thread to be serviced if damage occurs.

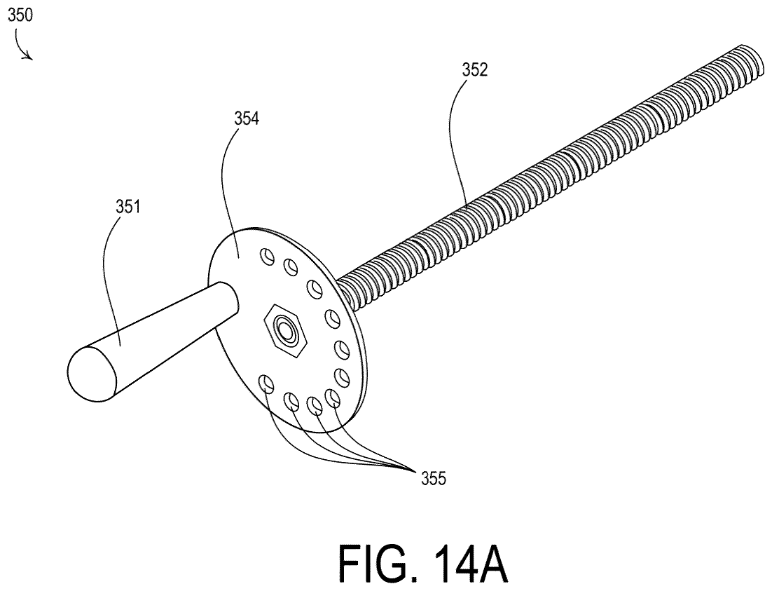

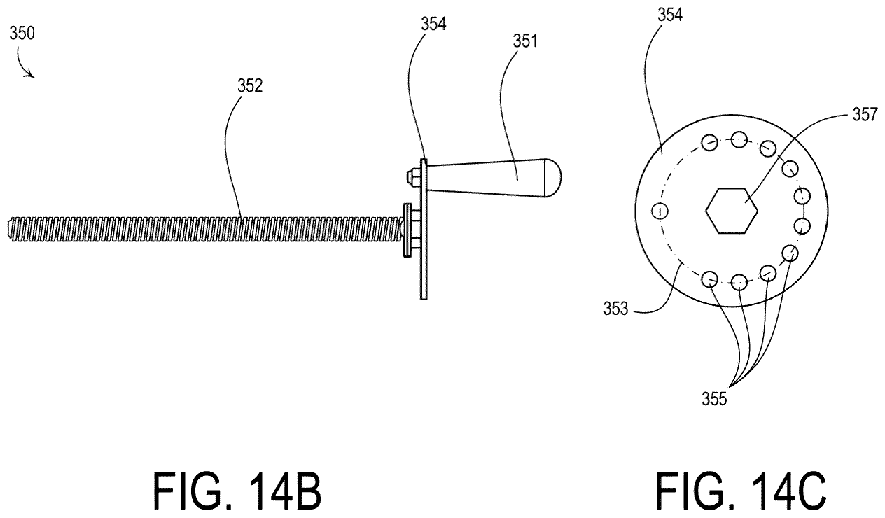

Each of the adjustment assemblies 350a, 350b may comprise a fastener 356. The fastener 356 may be configured to engage with one of a plurality of holes (e.g., such as holes 355 shown in FIG. 14A and 14C) in the plate 354, for example, to prevent operation of the respective one of the adjustment assemblies 350a, 350b. For example, the fastener 356 may abut the respective outer surface 312a, 312b of the side rails 310a, 310b to prevent operation of the adjustment assemblies 350a, 350b. It should be appreciated that the adjustment assemblies 350a, 350b may be implemented by alternative means. For example, the adjustment assemblies 350a, 350b may comprise a clamp or a vise.

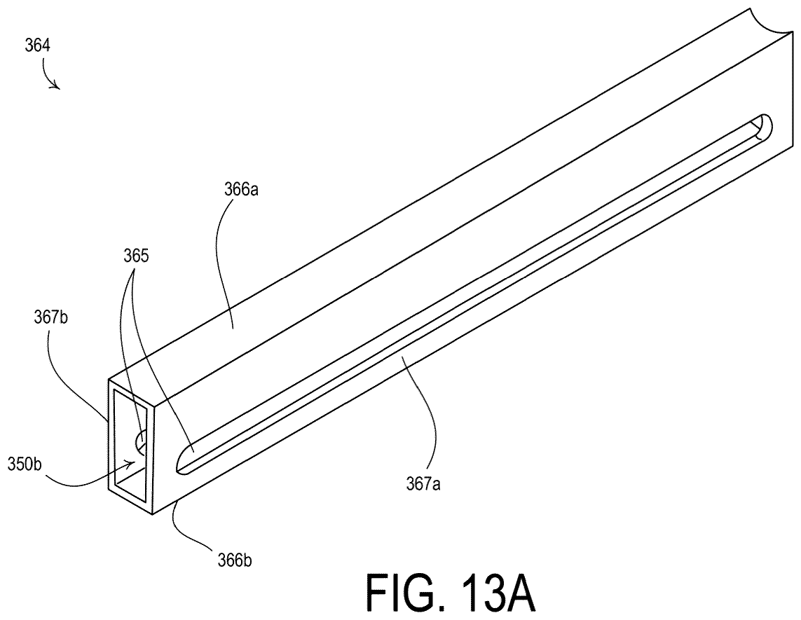

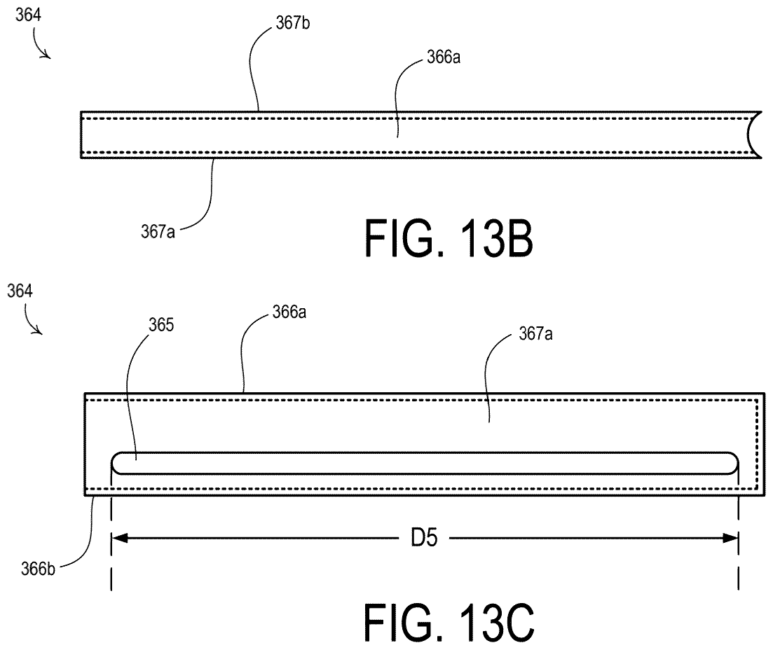

FIGS. 13A-13C depict detailed views of a rail portion 364 of the platform 360. The rail portion 364 may define an upper surface 366a, a lower surface 366b, and side surfaces 367a, 367b that extend between the upper surface 366a and the lower surface 366b. The rail portion 364 may be define a cavity 368. The rail portion 364 may define a slotted channel. For example, the rail portion 364 may define the slot 365. The slot 365 may extend through both side surfaces 367a, 367b of the rail portion 364. For example the bolts 348 may extend through both side surfaces 367a, 367b and through the cavity 368. The slot 365 may extend a distance D5 along the rail portion 364. The distance D5 may be in the range of 16 to 20 inches (e.g., 17.875 inches).

FIGS. 14A-14C depict detailed views of an adjustment assembly 350 that can be used as the adjustment assemblies 350a, 350b and/or the locking mechanisms 150a, 150b. The adjustment assembly 350 may comprise a hand crank 351 and a bolt 352. The hand crank 351 may be configured to be operated (e.g., rotated) by a user to secure the ladder 300 to the structure. The hand crank 351 may be secured to a plate 354 that is coupled to the bolt 352 such that rotations of the hand crank 351 are transferred to the bolt 352. The plate 354 may define a plurality of holes 355 therethrough. The plate 354 may be circular as shown. It should be appreciated that the plate 354 is not limited to being circular and may be alternatively shaped, for example, square, hexagonal, etc. The holes 355 may be configured to receive the fastener 356 to secure the plate 354 and the hand crank 351. The holes 355 may be arranged in a circular pattern defined by a circle 353 centered about a center of the plate 354. The plate 354 may define an aperture 357 that is configured to enable engagement of the bolt 352 to the plate 354. The aperture 357 may be hexagonal, for example, to receive a hexagonal nut therein.

What is claimed is:

1. A ladder for mounting to a structure, the ladder comprising:
a first side rail and a second side rail extending in a first direction, wherein the first side rail and the second side rail are parallel;
a plurality of rungs, each of the plurality of rungs extending between the first side rail and the second side rail;
an arm extending in a second direction, wherein when the ladder is mounted to a structure, the arm is configured to abut an inside surface of the structure and maintain a predetermined distance between the plurality of rungs and the structure;
a leg configured to extend proximate to an outside surface of the structure when the ladder is mounted to the structure, the leg configured to hinder movement of the plurality of rungs in the second direction; and
an adjustment assembly configured to be operated to secure the ladder to the structure.

2. The ladder of claim 1, further comprising a first slot on a first side of the ladder and a second slot on a second side of the ladder, wherein each of the first slot and the second slot are configured to receive one or more bolts to enable adjustment of a distance between the leg and the first and second side rails.

3. The ladder of claim 2, further comprising a platform that extends between the leg and the first and second side rails, the platform defining an upper surface and rail portions on opposed sides of the upper surface, wherein the first slot on the first side of the ladder is defined in a first rail portion and the second slot on the second side of the ladder is defined in the second rail portion.

4. The ladder of claim 3, wherein the first slot comprises two portions that extend in the range of 5 to 8 inches that are spaced apart in the range of 3 to 5 inches, and wherein the second slot comprises two portions that extend in the range of 5 to 8 inches that are spaced apart in the range of 3 to 5 inches.

5. The ladder of claim 3, wherein the first slot comprises one portion that extends in the range of 16 to 20 inches, and wherein the second slot comprise one portion that extends in the range of 16 to 20 inches.

6. The ladder of claim 3, wherein each of the slots extend through a first side surface of the respective first and second rail portions and through a second side surface of the respective first and second rail portions.

7. The ladder of claim 6, wherein the bolts extend through each of the slots from the first side surface of the respective first and second rail portions, through a cavity defined by respective first and second rail portions, and through a second side surface of the respective first and second rail portions.

8. The ladder of claim 3, wherein the upper surface is configured to allow a user to stand on the platform.

9. The ladder of claim 1, wherein the adjustment assembly is configured to be operated from the inside surface of the structure to secure the ladder to the structure.

10. The ladder of claim 1, wherein the adjustment assembly is configured to be operated from the outside surface of the structure to secure the ladder to the structure.

11. The ladder of claim 1, wherein the leg is adjusted to abut the structure when the adjustment assembly is operated.

12. The ladder of claim 11, wherein the leg is attached to an adapter that is configured to slidingly secure the leg to the ladder.

13. The ladder of claim 12, wherein the adjustment assembly is configured to be operated to adjust the ladder between a mounting position and a secured position.

14. The ladder of claim 13, wherein the adapter comprises a fastener that is configured to move within a slot defined in a platform of the ladder to guide the adapter in the second direction when the adjustment assembly is operated.

15. The ladder of claim 14, wherein the adjustment assembly comprises a hand crank that is configured to be operated by a user to secure the ladder to the structure.

16. The ladder of claim 14, wherein the arm is configured to abut the inside surface of the structure and the leg is configured to abut the outside surface of the structure when the ladder is in the secured position.

17. The ladder of claim 13, wherein the leg is spaced a first distance from the plurality of rungs when the ladder is in the mounting position and the leg is spaced a second distance from the plurality of rungs when the ladder is in the secured position, and wherein the first distance is greater than the second distance.

18. The ladder of claim 1, wherein the second direction is substantially orthogonal to the first direction.

19. The ladder of claim 1, wherein the leg is configured to extend in the first direction proximate to the outside surface of the structure when the ladder is mounted to the structure.

20. The ladder of claim 1, wherein each of the plurality of rungs defines opposed ends that are connected to respective side rails.

21. The ladder of claim 1, wherein the predetermined distance is measured between a respective rear surface of each of the plurality of rungs and an inside surface of the structure.

22. The ladder of claim 1, wherein the plurality of rungs is a first plurality of rungs and the arm is a first arm, the ladder further comprising an extension portion configured to be mounted to at least one of the first plurality of rungs, first side rail, or the second side rail, the extension portion comprising:
a third side rail and a fourth side rail extending in the first direction when the extension is mounted to the at least one of the first plurality of rungs, wherein the third side rail and fourth side rail are parallel;
a second plurality of rungs extending between the third side rail and the fourth side rail;
a second arm configured to extend in the second direction, wherein when the ladder is mounted to a structure, the second arm is configured to abut the inside surface of the structure; and
a connector configured to engage the at least one of the first plurality of rungs.

23. The ladder of claim 22, wherein the second arm is adjustable in the second direction to a plurality of lengths, and wherein the second arm defines a stationary portion and a translating portion, the translating portion configured to translate with respect to the stationary portion, and wherein the second arm comprises a lock configured to secure the translating portion to the stationary portion at each of the plurality of lengths.

24. The ladder of claim 1, further comprising a platform defining:
an upper surface between the first and second rails and the leg, wherein the upper surface is configured to enable a user to stand and access the first plurality of rungs when the ladder is mounted to the structure; and
a lower surface that is configured to abut the structure when the ladder is mounted to the structure.

25. The ladder of claim 24, further comprising a handrail extending above the platform when the ladder is mounted to the structure.

26. The ladder of claim 1, wherein the structure is a wall of a trench shoring system that is configured to be placed inside a trench.

27. The ladder of claim 1, wherein the adjustment assembly comprises a bolt, a bolted carriage, and a box tube, and wherein the box tube is configured to slidingly receive the bolted carriage that is operably coupled to the bolt to secure the ladder to the structure.

28-46. (canceled)
